(19) United States
(12) Patent Application Publication
(10) Pub. No.: US 2001/0018564 A1
(43) Pub. Date: Aug. 30, 2001

(54) Medical apparatus for facilitating blood circulation in the lower limbs

(75) Inventors: Dan Manor, Kadima (IL); Roni Bibi, Hertzelia (IL); Eli Levi, Ra'anana (IL)

Correspondence Address: FISH & NEAVE, 1251 AVENUE OF THE AMERICAS, 50TH FLOOR, NEW YORK, NY, 10020-1105, US

(73) Assignee: MEDICAL DYNAMICS (ISRAEL) 1998 LTD., Haifa (IL)

(21) Appl. No.: 09/740,667

(22) Filed: Dec. 18, 2000

Related U.S. Application Data
(63) Continuation of application No. 08/902,967, filed on Jul. 30, 1997, now abandoned.
Application No. 08/902,967 is a continuation-in-part of application No. 08/660,139, filed on Jun. 7, 1996, now abandoned.

(51) Int. Cl. A61H 7/00

(52) U.S. Cl. 601/152; 601/148

(57) ABSTRACT

A medical apparatus for facilitating and supporting blood circulation in a user's lower limb is provided. The apparatus comprises: (a) a sandal element, including: a sole element having inflatable chambers for selectively and independently applying pressure to distinct portions of the user's sole, each of the inflatable chambers being located at a specific portion of the sole element; and a shell element for fastening the sole element to the user's foot; and (b) an inflating system for independently inflating and deflating the inflatable chambers, preferably in a periodical manner. The inflating system may include: a pump; a valvular system for controlling the flow of fluid into and out of the inflatable chambers; a pressure sensor; and a controller. The user may specify the chambers to be inflated and deflated and the sequence of inflation and deflation, as well as the frequency of inflation and deflation and the operating time of the inflating system, thereby simulating any motor activity of the foot, including standing, walking and running. Further according to the present invention there is provided a medical apparatus, comprising: at least one elevating element, the at least one elevating element being adapted to engage substantially the front portion of a user's foot for elevating the front portion of the user's foot relative to the user's heel so as to activate the calf muscles of the user, thereby forcing venous blood upstream towards the user's heart. The front portion of the user's foot preferably includes the user's toes and metatarsus. The at least one elevating element is attached to a carrier adapted to receive a user's foot and includes a fixing element for fixing substantially the user's heel to the carrier.

This is a continuation in part of U.S. patent application Ser. No. 08/660,139, filed Jun. 7, 1996.

### FIELD AND BACKGROUND OF THE INVENTION

The present invention relates to a medical apparatus for facilitating and supporting blood circulation in a user's lower limb and, more particularly to an apparatus in the form of a sandal element having inflatable chambers located at distinct portions of the sandal element for selectively and independently applying pressure to distinct portions of the user's foot, thereby simulating any motor activity of the foot.

Blood circulation in the legs of a subject and specifically blood return from the lower limbs to the heart of a user via the venous circulation is generally dependent on the activation of motorical mechanisms, including passive and active mechanisms.

Passive mechanisms relate to emptying of a group of venous blood vessels located at the subject's foot, sometimes called the venous plexus of the foot, into the deep veins of the foot and calf, normally due to compression of the venous plexus. Compression of the venous plexus may be normally achieved due to weight bearing by the subject's foot in a standing position or by transient stretching of the venous blood vessels located mainly at the plantar arch of the subject's foot. The compression of the venous plexus forces the venous blood up the limb towards the heart thereby enabling the venous plexus to refill, for example, with new blood.

Active mechanisms relate to muscular activity in the user's calf which forces the venous blood cephalad and are normally activated by motorical activity of the lower limbs. Such muscular activity includes the activation of venous muscular pumps, and particularly a venous muscular pump located at the calf of the subject. Activation of such venous muscular pump is normally the result of regular walking activity, and in particular the last stage of each step wherein the user's metatarsus and toes carry most of the user's weight, and the user's toes are pressed against the floor, thereby changing their position relative to the rest of the foot. The activation of the venous muscular pump at the subject's calf results in sequential compression of the deep veins which are surrounded by the calf muscles, thereby forcing the venous blood within the deep veins upstream towards the subject's heart, overcoming the force of gravity.

Thus, the active mechanism triggered by the muscular venous pump at the subject's calf is complementary to the passive mechanism triggered by emptying of the venous plexus of the foot, since it supports the circulation of venous blood, previously forced into the calf by the compression of the venous plexus, towards the heart of the subject.

When inactivity of the legs is forced upon a person, then blood tends to accumulate in the venous plexus of the subject's feet, blood return to the heart is impaired, and conditions of deep vein thrombosis, edema, pulmonary emboli, and varicose veins may develop. Such impairment of blood circulation may be observed, for example, in individuals using wheelchairs, geriatric patients, patients going through long surgical procedures and individuals spending long periods of times in sitting or laying positions.

Various attempts have been made to provide an apparatus having inflatable chambers for exerting pressure on the foot of auser, thereby facilitating blood circulation in the user's limbs. Examples are disclosed in U.S. Pat. Nos. 5,354,260 and 5,443,440. However, such devices are designed to activate only the passive mechanism of compressing the venous plexus at the plantar arch of the foot, and not active mechanisms such as activation of the venous muscular pump located at the subject's calf. Therefore, although such devices provide means to force the blood accumulated in the subject's foot toward the subject's heart, they do not provide complementary means for physiological compression of the deep veins in the subject's calf and support of the venous circulation in the cephalad direction. Therefore, their effectiveness in facilitating blood circulation in the user's limbs is limited.

Specifically, the disclosed devices include one or two inflatable chambers for exerting relatively homogeneous pressure or pressures, respectively, on a broad area of the user's sole. None of these devices makes it possible to selectively apply pressure to a limited portion of the user's sole, for example, the user's toes, so as to selectively change the orientation of the limited portion relative to the rest of the foot. Accordingly, the disclosed devices do not make it possible to activate the venous muscular pump located at the user's calf, by changing the orientation of the toes relative to the rest of the foot.

Moreover, none of these devices makes it possible to independently inflate and deflate distinct inflatable chambers for independently applying pressure to different portions of the user's foot, thereby simulating any motor activity of the foot, such as standing, walking and running activities.

There is thus a widely recognized need for, and it would be highly advantageous to have, a medical apparatus for facilitating and supporting blood circulation in the user's lower limbs which makes it possible to activate passive mechanisms such as compression of the venous plexus of the foot and active mechanisms such as activation of the venous muscular pump at the subject's calf, thereby forcing the blood up the limbs toward the subject's heart and overcoming the force of gravity.

Specifically, it would be advantageous to have such device which enables to selectively and independently inflate distinct inflatable chambers so as to selectively and independently apply pressure to distinct portions of the user's foot. It would be farther advantageous to have such device which enables to change the orientation of such distinct portions relative to the rest of the foot. In particular, it would be advantageous to have such device which enables to selectively apply pressure to the toes and metatarsus of the user so as to change the orientation of the toes relative to the rest of the foot, thereby activating the venous muscular pump located at the user's calf.

It would be further advantageous to have a medical apparatus which enables to alternately and sequentially inflate and deflate distinct inflatable chambers so as to alternately apply pressure to distinct portions of the user's foot, thereby simulating any motor activity of the foot, such as walking and running.

It would be further advantageous to have such apparatus which is comfortable, compact, mobile and easy to handle; and which can be operated by means of batteries or a DC power supply of a car and therefore can be used everywhere.

### SUMMARY OF THE INVENTION

According to the present invention there is provided a medical apparatus for facilitating and supporting blood circulation in a user's lower limb, comprising: (a) a sandal element, including: a sole element having inflatable chambers, each of the inflatable chambers being located at a specific portion of the sole element for selectively applying pressure to distinct portions of the user's sole, each of the inflatable chambers controllably inflatable and deflatable at a specific timing so as to independently apply pressure to the distinct portions of the user's sole; and a shell element for fastening the sole element to the user's foot; and (b) an inflating system for inflating and deflating the inflatable chambers in a controllable manner.

According to further features in preferred embodiments of the invention described below, the shell element may include one or more closure members for fastening the shell element around the user's foot.

According to still further features in the described preferred embodiments, each of the inflatable chambers may feature a specific maximal pressure value while in its inflated form. Further, each of the inflatable chambers may feature walls of a specific flexibility, so that each of the chambers features a specific height or a specific volume in its maximal inflated form.

Further, the inflatable chambers may feature any shape for efficiently applying pressure against the respective parts of the user's sole.

The inflatable chambers may be independently inflated and deflated according to any specific sequence so as to simulate any specific motor activity of the user's foot.

The frequency of inflation and deflation and the operating time of the inflating system may be predetermined by the user so as to simulate different rates and durations of motor activities. Further, the specific maximal pressure value within each of the inflatable chambers may be predetermined by the user.

According to additional features of the invention described below, the sole element may include: a first inflatable chamber adapted to engage the user's heel; a second inflatable chamber adapted to engage the user's plantar arch; a third inflatable chamber adapted to engage the user's metatarsus; and a fourth inflatable chamber adapted to engage the user's toes.

The sequence of inflation and deflation may include inflation and subsequent deflation of the first, second, third and fourth chambers, so as to alternately and sequentially apply pressure to the heel, plantar arch, metatarsus and toes of the user, thereby simulating walking, running, or any other activity.

According to another embodiment, the sequence of inflation and deflation may include simultaneous inflation of the first, second, third, and fourth chambers and then simultaneous deflation of these chambers, so as to simultaneously apply pressure to the entire venous circulation of the user's foot. While using such embodiment, each of the chambers may feature a specific maximal pressure so as to simulate, for example, standing condition of the user.

Alternatively, the sequence of inflation and deflation may include sequential inflation of the first, second, third, and fourth chambers, and then sequential deflation of the first, second, third, and fourth chambers.

The chambers to be inflated and deflated may predeterminately be selected by the user, so that only the selected chambers take part in the cycle of inflation and deflation.

Thus, according to another embodiment of the invention, the sequence of inflation and deflation may include inflation and subsequent deflation of the second and the forth chambers, so as to alternately and sequentially apply pressure to the plantar arch and toes of the user, thereby compressing the user's venous plexus and activating the venous muscular pump located at the user's calf.

An inflating system according to the present invention may preferably include: a pump for pumping fluid into the inflatable chambers; a valvular system for controlling the flow of fluid into and out of the inflatable chambers, the valvular system including tubular elements each having a valve, each of the tubular elements being connected to a distinct inflatable chamber; a pressure sensor for sensing the pressure within the valvular system; and a controller for controlling the operation of the pump and the valvular system according to the pressure sensed by the pressure sensor.

Further according to the present invention there is provided a medical apparatus, comprising: at least one elevating element, the at least one elevating element being adapted to engage substantially the front portion of the user's foot for elevating the front portion of the user's foot relative to the user's heel so as to activate the calf muscles of the user, thereby forcing blood upstream towards the user's heart. The front portion of the user's foot preferably includes the user's toes and metatarsus.

Preferably, the at least one elevating element is attached to a carrier adapted to receive a user's foot and includes a fixing element for fixing substantially the user's heel to the carrier.

The at least one elevating element may be an inflatable chamber, and may be attached to a platform of a wheelchair.

According to further features of the preferred embodiments, the inflatable chamber is inflated and deflated according to a predetermined frequency. Further, the inflatable chamber features a specific height in its inflated form.

Further according to the present invention there is provided a medical apparatus, comprising: a first carrier for receiving a user's right foot and a second carrier for receiving a user's left foot, the first carrier including at least one first elevating element for engaging substantially the front portion of the user's right foot relative to the user's right heel and the second carrier including at least one second elevating element for engaging substantially the front portion of the user's left foot relative to the user's left heel. The first and second elevating elements may be raised simultaneously. Alternatively, the first and second elevating elements are raised independently.

The present invention successfully addresses the shortcomings of the presently known configurations by providing a medical apparatus for effectively facilitating and supporting blood circulation in a user's lower limb which makes it possible to activate the muscular pump at the subject's calf, thereby allowing to force blood up the limbs toward the subject's heart in a physiological manner.

Specifically, the present invention addresses the shortcomings of the presently known configurations by providing a medical apparatus which enables to selectively and independently apply pressure to a distinct portion of the user's foot, thereby changing the position of the distinct portion relative to the rest of the foot. For example, such apparatus enables to change the position of the user's toes relative to the rest of the foot, thereby activating the venous muscular pump located at the user's calf.

Alternatively, a medical apparatus according to the present invention enables to elevate substantially the front portion of the user's foot relative to the user's heel thereby activating the muscles at the user's calf and thus forcing blood within the deep veins upstream towards the user's heart.

Further, the present invention addresses the shortcomings of the presently known configurations by providing a medical apparatus which enables to alternately and sequentially apply pressure to distinct portions of the user's foot, thereby simulating any motor activity of the foot, including walking and running.

The present invention discloses a novel medical apparatus comprising: a sandal element including a sole element having inflatable chambers and a shell element; and an inflating system for independently inflating and deflating distinct inflatable chambers. The user may specify the chambers to be inflated and deflated and the sequence of inflation and deflation. The user may further specify the maximal pressure value to be adopted by each chamber, as well as the frequency of inflation and deflation and the operating time of the inflating system, so as to simulate any motor activity of the foot at different pressures, rates, and durations respectively. While selecting sequential inflation and deflation of adjacent chambers starting from the heel, the apparatus may simulate walking activities at different rates, as well as running activities. While selecting any other sequence of inflation and deflation of chambers, the apparatus may simulate any other motor activity of the foot.

Further, the present invention discloses a novel medical apparatus comprising: a carrier for receiving a user's foot, the carrier including at least one elevating element such as an inflatable chamber, the at least one inflatable chamber being adapted to engage substantially the front portion of the user's foot. The user positions his foot on the carrier such that the inflatable chamber engages preferably the toes and metatarsus portions of the foot. The user then inflates and deflates the inflatable chamber according to a predetermined frequency so as to alternately elevate the front portion of his foot, thereby alternately activating the calf muscles, thereby forcing blood upstream towards the heart.

### BRIEF DESCRIPTION OF THE DRAWINGS

The invention is herein described, by way of example only, with reference to the accompanying drawings, wherein:

FIG. 1a is a top view of a sandal element according to the present invention, in a configuration adopted while attached to the user's foot;

FIG. 1b is a top view of the sandal element shown in FIG. 1a, in an extended configuration;

FIG. 1c is a schematic side view, partially in longitudinal section, of a sole element according to the present invention;

FIG. 2a is a top view of another embodiment of a sandal element according to the present invention, in an extended configuration;

FIG. 2b is a bottom view of the embodiment shown in FIG. 2a, in an extended configuration;

FIG. 2c is a side view of the embodiment shown in FIG. 2a;

FIG. 3 is a schematic diagram of a possible embodiment of inflating system according to the present invention;

FIG. 4 is a schematic graph illustrating a possible sequence of alternate inflations and deflations of distinct inflatable chambers of a sandal element according to the present invention expressed by the pressure values built within each of the inflatable chambers as a function of time.

FIGS. 5 and 6 show a schematic side view of another preferred embodiment of a medical apparatus according to the present invention.

FIG. 7 shows a preferred embodiment of the present invention adapted for use with a wheelchair.

FIG. 8 shows a schematic top view of yet another preferred embodiment of the present invention.

### DESCRIPTION OF THE PREFERRED EMBODIMENTS

The present invention is of a medical apparatus for facilitating and supporting blood circulation in a user's lower limb by selectively applying pressure to distinct portions of the user's foot. Specifically, the present invention may be used to independently inflate and deflate distinct inflatable chambers so as to selectively and alternately apply pressure to distinct portions of the user's foot, thereby simulating any motor activity of the foot, such as walking and running.

The principles and operation of a device according to the present invention may be better understood with reference to the drawings and the accompanying description.

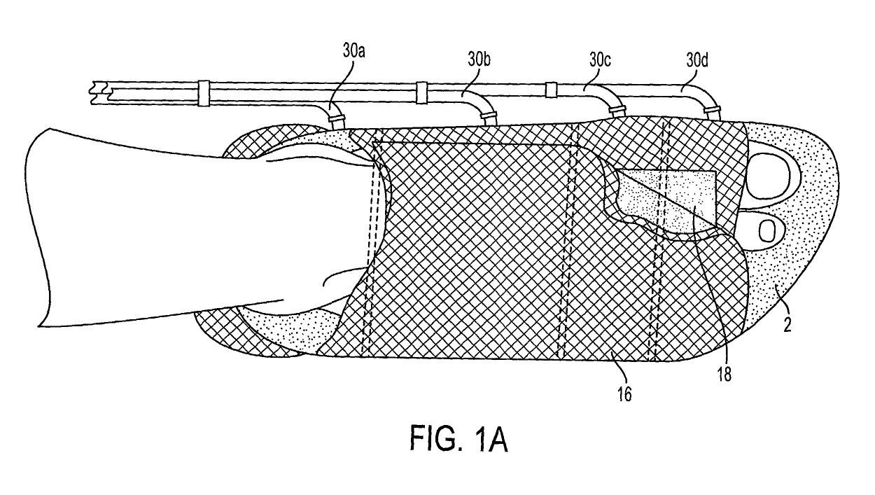

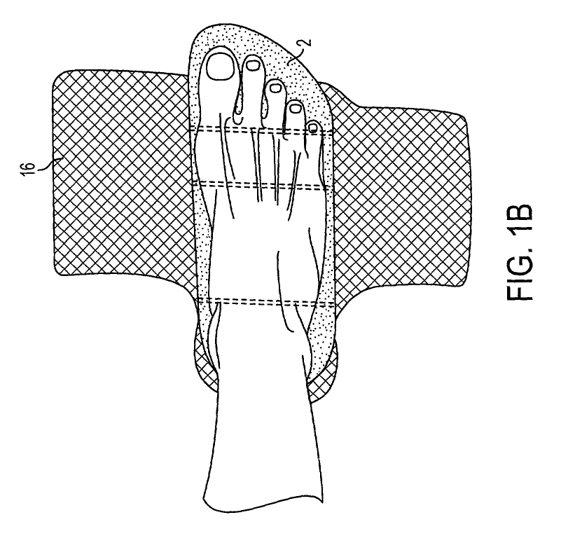

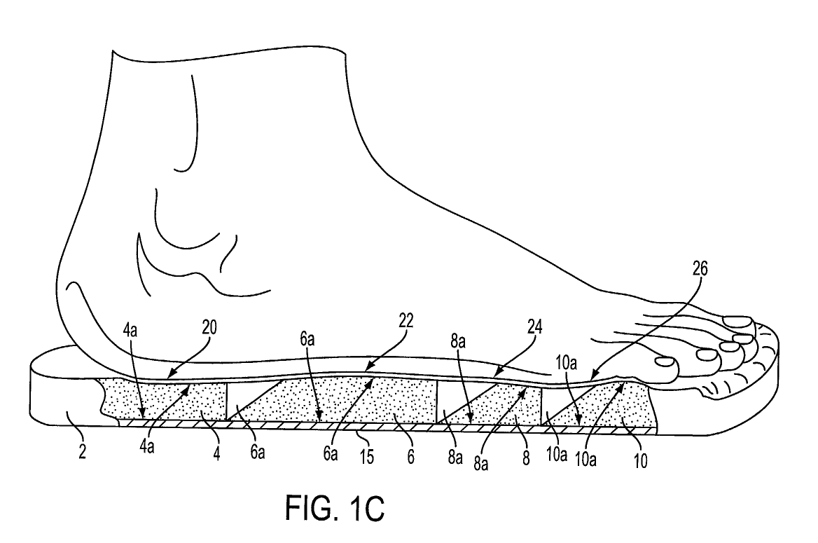

Referring now to the drawings, FIGS. 1a, b and c illustrate a sandal element of a medical apparatus according to the present invention. The sandal element comprises a sole element 2 for receiving the foot of a user and a shell element 16 for fastening sole element 2 to the user's foot. Shell element 16 may include at least one closure element 18 for fastening shell element 16 around the user's foot. Closure element 18 may be, for example, a Velcro fragment.

As shown in FIG. 1c, sole element 2 includes a plurality of inflatable chambers. For example, sole element 2 may include four inflatable chambers 4, 6, 8, and 10 adapted to engage the heel 20, plantar arch 22, metatarsus 24, and toes 26 of the user's foot.

Preferably, sole element 2 includes a rigid base layer 15 made of, for example, cardboard, plastic, or any other material, coated with polyvinyl chloride. The walls 4a, 6a, 8a and 10a of inflatable chambers 4, 6, 8 and 10 respectively, are preferably made of polyvinyl chloride, polyurethane or other types of plastic.

Each of walls 4a, 6a, 8a and 10a of inflatable chambers 4, 6, 8 and 10 respectively, may feature a specific flexibility so that each of the inflatable chambers features a specific height and a specific volume while in its maximal inflated form.

As shown in FIG. 1c, inflatable chambers 4, 6, 8 and 10 may simultaneously be heat-sealed such that the walls forming partitions between the inflatable chambers. Preferably, the inflatable chambers may simultaneously be heat sealed with tubing connections for connecting the chambers to an inflating system. Alternatively, inflatable chambers 4, 6, 8 and 10 may simultaneously be sealed by means of, for example, ultrasound or RF. The inflatable chambers may be secured to base layer 15 by any securing means, such as adhesive.

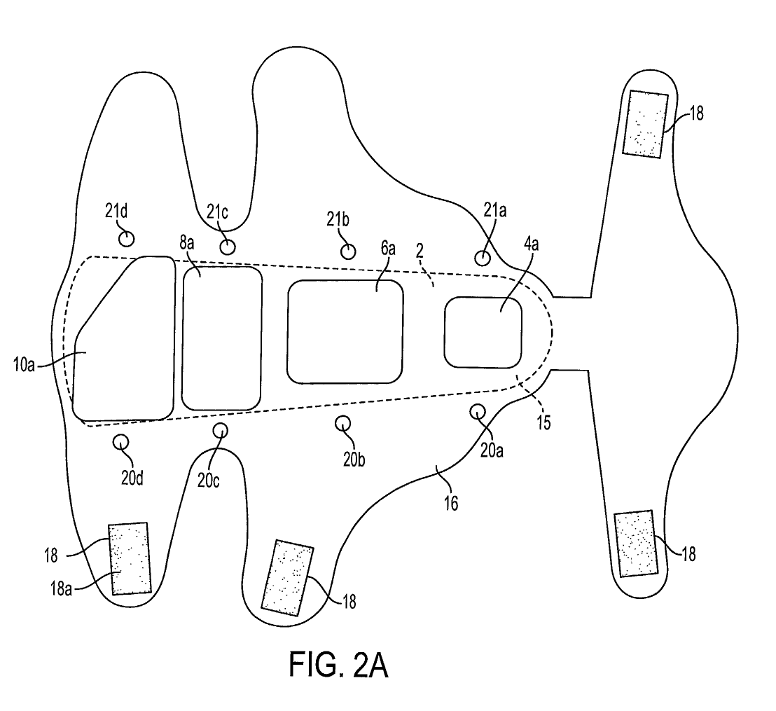

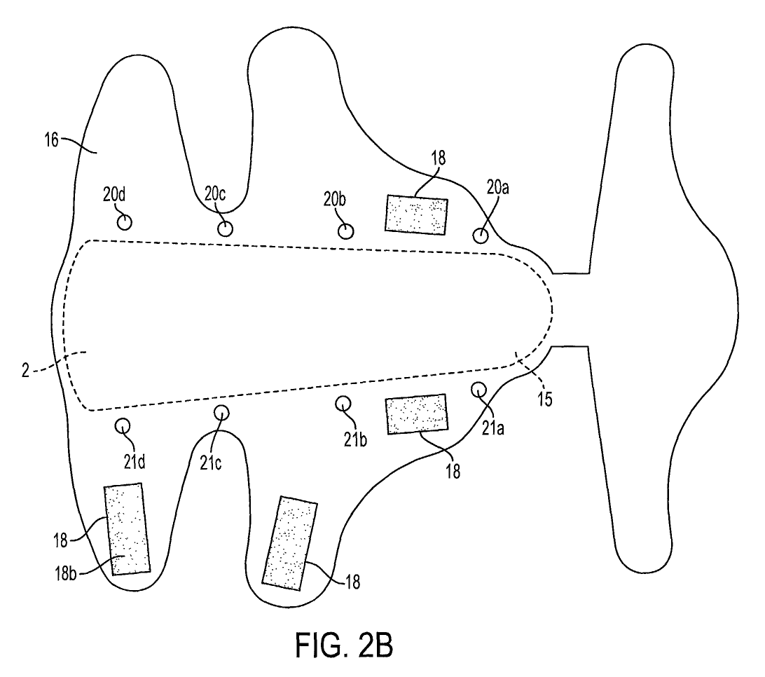

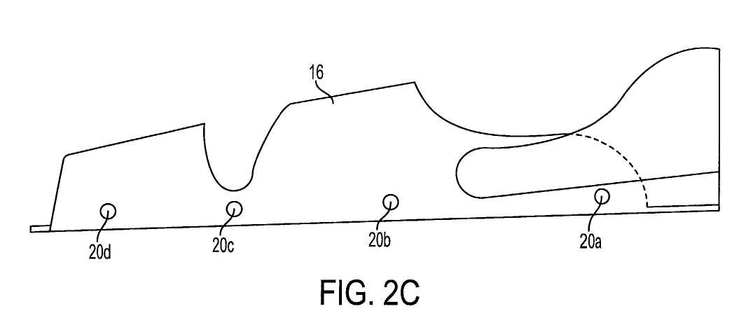

Another possible configuration is shown in FIGS. 2a, b and c. In this configuration, inflatable chambers 4, 6, 8 and 10 are individually heat-sealed or sealed by means of, for example, ultrasound or RF, and secured to base layer 15 by any securing means.

Each of inflatable chambers 4, 6, 8 and 10 may feature a specific size and shape for efficiently applying pressure against the respective parts of the user's sole.

As shown in FIGS. 2a, b, and c, shell element 16 may preferably feature a plurality of closure members 18 for fastening shell element 16 around the user's foot. Closure members 18 may be, for example, refined 18b and unrefined 18a Velcro fragments.

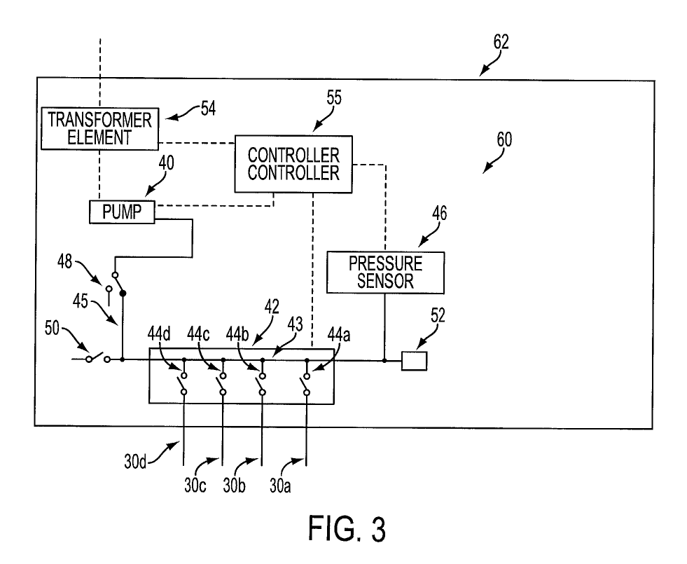

As shown in FIGS. 1a and 2a, b and c, shell element 16 may feature openings 20a, 20b, 20c and 20d for receiving tubular elements 30a, 30b, 30c and 30d respectively, the tubular elements being connected to an inflating system such as inflating system 60 (FIG. 3) for controllably inflating and deflating inflatable chambers 4, 6, 8 and 10. Shell element 16 may further include openings 21a, 21b, 21c and 21d for receiving tubular elements 30a, 30b, 30c and 30d respectively, so as to allow a convenient connection of inflating system 60 to sandal elements attached to the left foot and to the right foot of a user.

FIG. 3 illustrates a possible embodiment of an inflating system according to the present invention for controllably inflating and deflating inflatable chambers 4, 6, 8 and 10, preferably at a periodical manner. As shown in the Figure, inflating system 60 preferably comprises: a pump 40 for pumping fluid such as air into inflatable chambers 4, 6, 8 and 10; a valvular system 42 for controlling the flow of fluid into and out of the inflatable chambers; a pressure sensor 46 for sensing the pressure within valvular system 42; and a controller 55 for controlling the operation of inflating system 60.

Pump 40 may preferably be electrically connected to a transformer element 54 connectable to an AC or a DC electrical power supply. Further, pump 40 is preferably electrically connected to controller 55. Inflating system 60 may include a plurality of pumps 40 for facilitating the buildup of pressure within the inflatable chambers.

Inflating system 60 may further include a fluid container (not shown) for temporarily housing the fluid pumped by pump 40 into valvular system 42.

Inflating system 60 may further include a valve 48 for controllably directing the fluid pumped by pump 40 into valvular system 42 or to atmosphere, so as to enable efficient inflation and deflation of inflatable chambers 4, 6, 8 and 10. Valve 48 is electrically connected to controller 55.

Valvular system 42 includes a plurality of tubular elements, each connectable to a distinct inflatable chamber. According to the configuration shown in FIG. 3, valvular system 42 includes four tubular elements 30a, 30b, 30c and 30d connectable to inflatable chambers 4, 6, 8 and 10 respectively. Tubular elements 30a, 30b, 30c and 30d are preferably connected to a main manifold element 43, one end of which is connected to pump 40 by means of tubular element 45. Tubular manifold 43 may preferably be made of aluminum or any other material. Alternatively, each of tubular elements 30a, 30b, 30c and 30d may be individually connected to a distinct pump for allowing independent inflation and deflation of the inflatable chambers.

Each of tubular elements 30a, 30b, 30c and 30d includes a valve 44a, 44b, 44c and 44d respectively, for controlling the flow of fluid into and out of inflatable chambers 4, 6, 8 and 10 respectively, thereby controlling the inflation and deflation of said inflatable chambers. Each of valves 44a, 44b, 44c and 44d is electrically connected to controller 55.

Each of valves 44a, 44b, 44c and 44d has two possible states, one of which allowing flow communication between manifold element 43 and chambers 4, 6, 8, and 10, respectively, and the other of which blocking flow communication between manifold element 43 and said chambers, respectively.

Pressure sensor 46 is connected to valvular system 42 by means of manifold element 43, and senses the pressure within manifold element 43. Pressure sensor 46 is electrically connected to controller 55.

Alternatively, inflating system 60 may include a plurality of pressure sensors, each connected to a distinct tubular element 30a, 30b, 30c and 30d, for sensing the pressure within tubular elements 30a, 30b, 30c and 30d respectively.

Inflating system 60 may further include a valve SO for allowing the deflation of chambers 4, 6, 8, and 10.

Further, inflating system 60 may include a safety releaser 52 for releasing fluid to atmosphere upon a specific pressure value sensed by pressure sensor 46.

Preferably, controller 55 controls the operation of: pump 40; valvular system 42 including valves 44a, 44b, 44c and 44d; and valves 48 and 50, according to the pressure sensed by pressure sensor 46.

Each of tubular elements 30a, 30b, 30c and 30d may branch to two tubular elements, one of which connectable to a respective inflatable chamber 4, 6, 8 and 10 of a right sandal element, and the other connectable to a respective inflatable chamber 4, 6, 8 and 10 of a left sandal element. This configuration allows identical simultaneous operation of a right sandal element and a left sandal element.

Alternatively, inflating system 60 may include an additional set of valves, said set being connectable to manifold element 43, so that one set of valves is connectable to a right sandal element and the other set of valves is connectable to a left sandal element. This configuration allows alternate operation or any coordinated or independent operation of a right sandal element and a left sandal element.

Preferably, transformer element 54, pump 40, valvular system 42, pressure sensor 46, valves 48 and 50, safety releaser 52 and controller 55 are placed within a housing 62. Housing 62 preferably includes a controlling panel for setting various parameters by the user, such as: specification of the chambers to be inflated and deflated and the sequence of inflation and deflation; specification of the maximal pressure values and the pressure profiles within the inflatable chambers; selection of the frequency of inflation and deflation and the operating time of inflating system 60; and selection of one or two operating sandal elements.

Alternatively, the controlling panel may be placed at a remote control element, the remote control element being electrically connected to controller 55.

Inflating system 60 may be adapted to serve several patients, such that each patient uses one or two sandal elements. Accordingly, each of tubular elements 30a, 30b, 30c and 30d may branch to a plurality of tubular elements, each tubular element connectable to a distinct chamber of a distinct sandal element.

Alternatively, inflating system 60 may include a plurality of valvular systems 42 connectable to a main valvular system for controlling the operation of valvular systems 42, each of valvular systems 42 controlling the operation of one or two sandal elements of a distinct patient.

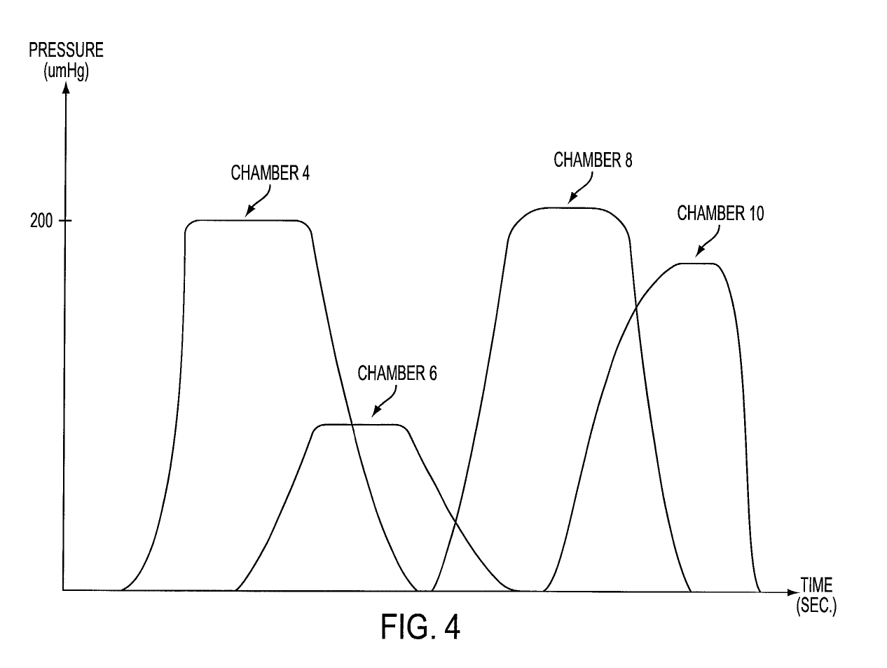

Preferably, inflating system 60 independently inflates and deflates the inflatable chambers according to a specific sequence set by the user, so as to simulate any specific motor activity of the foot. Referring now to FIG. 4, the sequence of inflation and deflation may include, for example, inflation and subsequent deflation of chamber 4, chamber 6, chamber 8, and chamber 10, so as to sequentially and alternately compress the heel 20, plantar arch 22, metatarsus 24, and toes 26 of the user, thereby simulating, for example, walking or running activity.

As shown in FIG. 4, each of inflatable chambers 4, 6, 8, and 10 preferably features a specific pressure profile and a specific maximal pressure value, so as to simulate pressures experienced by the user while exercising, for example, walking activity. However, the specific maximal pressure values within each of chambers 4, 6, 8 and 10 may be predetermined by the user. Further, the specific pressure profiles, i.e., the pressure-buildup and pressure-relaxation within each of the chambers as a function of time, may be predetermined by the user.

The frequency of inflation and deflation of chambers 4, 6, 8 and 10 at a given cycle of inflation and deflation may be predetermined by the user. Further, the time between a given cycle and the next cycle of inflation and deflation of chambers 4, 6, 8 and 10 may be predetermined by the user, so as to simulate waking activities at different rates, as well as running activity.

Further, the operating time of inflating system 60 may be predetermined by the user so as to simulate different durations of walking activity, running activity, standing, or any other motor activity.

The specification of the inflatable chambers to be inflated and deflated, as well as the sequence of inflation and deflation may be predetermined by the user. Thus, according to another embodiment, the sequence of inflation and deflation may include inflation and subsequent deflation of chamber 2 and then inflation and subsequent deflation of chamber 4, so as to sequentially and alternately apply pressure to the plantar arch 22 and toes 26 of the user, thereby compressing the user's venous plexus and sequentially activating the venous muscular pump at the user's calf.

According to additional embodiment, the sequence of inflation and deflation may include simultaneous inflation of chambers 4, 6, 8 and 10, and then simultaneous deflation of chambers 4, 6, 8 and 10, so as to simultaneously apply pressure to the heel, plantar arch, metatarsus and toes of the user, thereby applying pressure to the entire venous circulation of the user's foot. While using such embodiment, each of the chambers may feature a specific maximal pressure so as to simulate, for example, standing conditions of the user.

Alternatively, the sequence of inflation and deflation may include sequential inflation of chambers 4, 6, 8 and 10, and then sequential deflation of chambers 4, 6, 8 and 10.

Referring now to the specific example shown in FIG. 4. While using this configuration, pump 40 pumps fluid into valvular system 42 for independently inflating and deflating chambers 4, 6, 8 and 10.

Initially, valves 48 and 50 (FIG. 3) are set by controller 55 to allow flow of fluid from pump 40 to valvular system 42. Valvular system 42 is set by controller 55 to allow flow of fluid only into chamber 4. This is done by setting valve 44a to allow fluid communication between manifold element 43 and tubular element 30a.

Pressure sensor 46 senses the pressure within manifold element 43. When the pressure sensed by pressure sensor 46 becomes equal to the pressure value selected for chamber 4, valve 44a is set by controller 55 to stop the inflation of chamber 4. Then, valve 44b is set to allow inflation of chamber 6.

When the pressure sensed by pressure sensor 46 becomes equal to the pressure value selected for chamber 6, valve 44b is set by controller 55 to stop the inflation of chamber 6, and valve 44a is set to allow deflation of chamber 4. During the deflation of chamber 4, valve 48 is set by controller 55 to direct the fluid pumped by pump 40 to atmosphere, and valve 50 is set to allow release of fluid trapped within the system. After the deflation of chamber 4, valve 44a is set to stop flow communication between chamber 4 and manifold element 43, and valve 44b is set to allow the deflation of chamber 6.

When chamber 6 is partially deflated, valve 44b is set to stop the deflation of chamber 6, valves 48 and 50 are set to allow flow of fluid from pump 40 to valvular system 42, and valve 44c is set to allow inflation of chamber 8.

When chamber 8 is partially inflated, valve 44c is set to stop the inflation of chamber 8, valve 48 is set to direct the fluid pumped by pump 40 to atmosphere and valve 50 is set to allow release of fluid trapped within the system, and valve 44b is set to allow the deflation of chamber 6. When chamber 6 is completely deflated, valve 44b is set to stop flow communication between chamber 6 and manifold element 43, valves 48 and 50 are set to allow flow of fluid from pump 40 to valvular system 42, and valve 44c is set to allow inflation of chamber 8. The deflation of chamber 8 and inflation of chamber 10 is then carried out in a similar manner.

When the pressure sensed by pressure sensor 46 becomes equal to the pressure value selected for chamber 10, valve 44d is set by controller 55 to stop the inflation of chamber 10. Valve 44d is then set by controller 55 to allow deflation of chamber 10.

Further, controller 55 sets valve 48 to direct the fluid pumped by pump 40 out to atmosphere, until the next cycle of inflation and deflation of chambers 4, 6, 8 and 10. Alternatively, valve 48 is maintained at a position for allowing flow communication between pump 40 and a fluid container, so that the fluid pumped by pump 40 is accumulated within the fluid container until the next cycle of inflation and deflation of chambers 4, 6, 8 and 10. During this time, valve 50 is set by controller 55 to allow release of fluid trapped within the system.

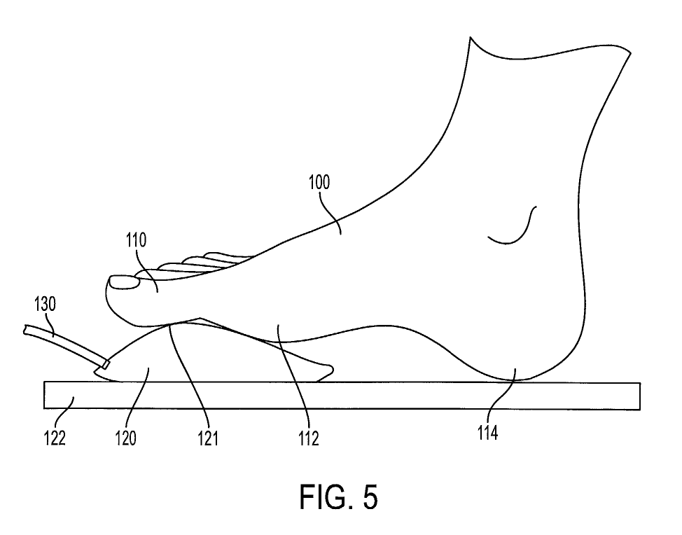

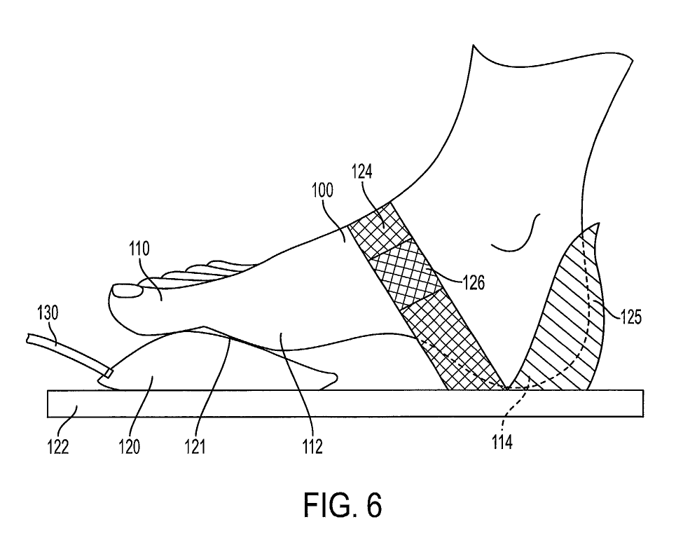

Another preferred embodiment of a medical apparatus according to the present invention is shown in FIGS. 5 and 6. Preferably, an elevating element such as an inflatable chamber 120 is used to elevate substantially the front portion of a user's foot 100 relative to the user's heel 114, wherein the front portion of the user's foot preferably includes the toes 110 and metatarsus 112 portions of the foot. By elevating substantially the front portion of the foot 100 relative to heel 114, the muscles at the user's calf are activated, thereby forcing blood within the venous circulation upstream towards the subject's heart.

As shown in FIGS. 5 and 6, the medical apparatus preferably includes an inflatable and deflatable chamber 120 having an upper side 121 for engaging the foot of a user, chamber 120 being in fluid communication with a tube 130 connected to an inflating system (not shown) for inflating and deflating chamber 120 according to a predetermined frequency.

Inflatable chamber 120 may be positioned on the floor. Alternatively, inflatable chamber 120 may be attached to a carrier adapted to receive a user's foot such as a portable planar surface 122. The attachment may be made, for example, by sealing or sticking inflatable chamber 120 to surface 122. Alternatively, inflatable chamber 120 may be detachably attached to surface 122 by means of Velcro fragments.

Thus, planar surface 122 may be positioned, for example, on a platform of a wheelchair. Alternatively, planar surface 122 may be positioned on or detachably connected to a special stand, the stand being adjacent or connected to a patient's bed, so that the patient can use the device while he is sitting or laying in bed.

As shown in FIG. 6, the apparatus may include a fixing element 124 such as a strap for securing the user's foot to surface 122. Fixing element 124 may include a closure member 126 for fastening fixing element 124 to the user's foot. Closure member 126 may be made, for example, of Velcro fragments. When fixing element 124 is a strap, the strap preferably encloses the tarsus portion of the patient's foot (FIG. 6) so that the heel 114 is firmly secured to surface 122, and preferably serves as an axis for the foot's movement.

As shown in the figure, the apparatus may further include a supporting element 125 for supporting the heel portion 114 of the user. Supporting element 125 may be made as an integral part of carrier 122 and may be formed as an extension perpendicular to carrier 122.

The apparatus may be used by the disabled user while he is wearing his own shoes, thereby allowing him to enjoy the therapy without the burden associated with taking off his shoes.

According to another embodiment (not shown) the medical apparatus includes a shell element for enclosing the user's foot.

According to yet another embodiment (not shown), two inflatable chambers 120 for engaging right and left feet of a user are attached to a common surface 122.

According to further features of the present invention, upper side 121 of inflatable chamber 120 preferably features a predetermined flexibility so as to enable inflation of chamber 120 to a specific predetermined height upon application of fluid such as air of a specific pressure to chamber 120. The specific height of chamber 120 in its inflated form is thus determined by the flexibility of its upper side 121 and the pressure of fluid applied to chamber 120. Preferably, the rate of inflation of chamber 120 is predetermined.

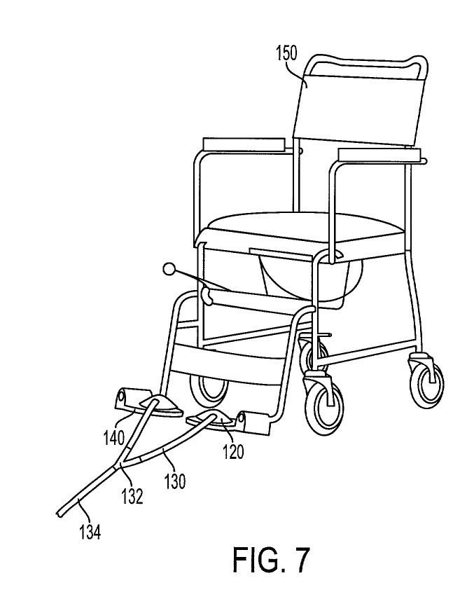

FIG. 7 shows a specific example wherein two inflatable chambers 120 are positioned on respective platforms 140 of a wheelchair 150. Inflatable chambers 120 may be attached to platforms 140, for example, by means of Velcro fragments. The user sits on wheelchair 150 and positions his feet on platforms 140 such that inflatable chambers 120 overlap substantially the pertinent front portions of his feet. Thus, when inflatable chambers 120 are inflated, the calf muscles are activated and blood is thus forced upstream towards the user's heart.

As shown in FIG. 7, each of inflatable chambers 120 is in fluid communication with a respective tube 130, tubes 130 being connected by means of a connector 132 to a common tube 134 in fluid communication with an inflating system (not shown). According to such embodiment, chambers 120 are simultaneously inflated and deflated at a specific desired frequency.

According to another embodiment (not shown), each of tubes 130 is preferably connected to a conventional mechanical valve controlled by the inflating system so as to enable independent inflation and deflation of each of chambers 120. The mechanical valve is preferably in the form of a standard valve frequently used in pressure-sores mattress systems. Alternatively, tubes 130 are connected to a pneumatic valvular system constructed according to the principles described hereinabove.

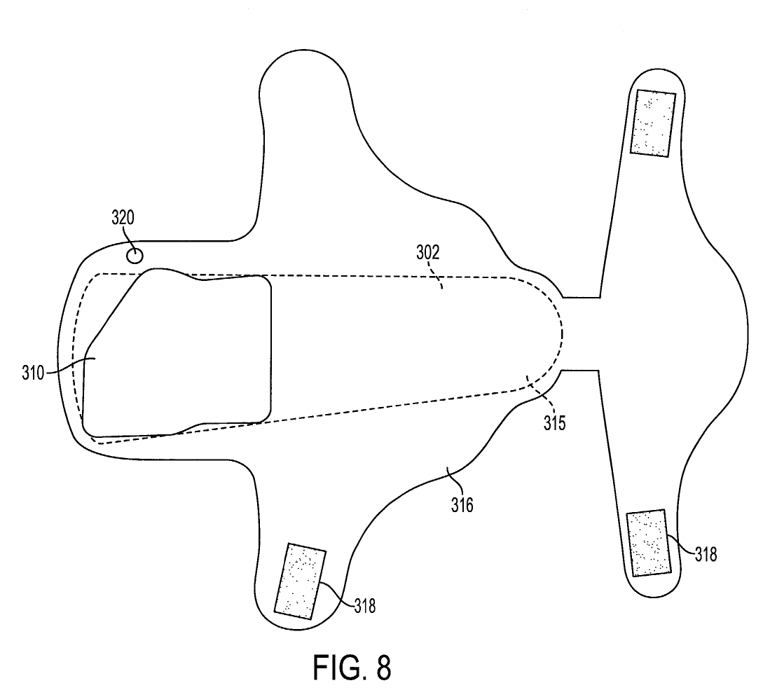

Referring now to FIG. 8, a medical apparatus according to the present invention may be in the form of a sandal element including at least one inflatable chamber for engaging substantially the front portion of a user's foot. As shown in the figure, the sandal element includes a sole element 302 having a rigid base layer 315 and a fixing element 316 for fixing substantially the user's heel to sole element 302. Fixing element 316 may be in the form of a shell element and may include closure members 318 such as Velcro fragments for fastening the shell element around the user's foot, thereby fixing substantially the user's heel to sole element 302.

Sole element 302 preferably includes at least one inflatable chamber 310 for engaging substantially the front portion of the user's foot. Preferably, the front portion of the user's foot includes the toes and metatarsus portions of the foot. As shown in the figure, Shell element 316 preferably includes at least one opening 320 for receiving a tube therein, the tube being in fluid communication with an inflating system.

While the invention has been described with respect to a limited number of embodiments, it will be appreciated that many variations, modifications and other applications of the invention may be made.

What is claimed is:

1. A medical apparatus for facilitating blood circulation in a user's lower limb, comprising:
at least one elevating element, said at least one elevating element being adapted to engage substantially the front portion of the user's foot for elevating the front portion of the user's foot relative to the user's heel so as to activate the calf muscles of the user, thereby forcing venous blood upstream towards the user's heart.

2. The medical apparatus of claim 1 wherein said at least one elevating element is at least one inflatable chamber.

3. The medical apparatus of claim 1 wherein said at least one elevating element is attached to a platform of a wheelchair.

4. The medical apparatus of claim 1 wherein said at least one elevating element is attached to a carrier adapted to receive a user's foot.

5. The medical apparatus of claim 4 wherein said carrier includes a fixing element for fixing substantially the user's heel to said carrier.

6. The medical apparatus of claim 2 wherein said at least one inflatable chamber is inflated and deflated according to a predetermined frequency.

7. The medical apparatus of claim 2 wherein said at least one inflatable chamber features a specific height in its inflated form.

8. A medical apparatus for facilitating blood circulation in a user's lower limb, comprising:
a carrier for receiving a user's foot, said carrier including at least one elevating element, said at least one elevating element being adapted to engage substantially the front portion of the user's foot for elevating the front portion of the user's foot relative to the user's heel so as to activate the calf muscles of the user, thereby forcing venous blood upstream towards the user's heart.

9. The medical apparatus of claim 8 wherein said at least one elevating element is at least one inflatable chamber.

10. The medical apparatus of claim 8, wherein said front portion of the user's foot includes the user's toes.

11. The medical apparatus of claim 8, wherein said front portion of the user's foot includes the user's metatarsus.

12. The medical apparatus of claim 8, wherein said medical apparatus further comprises a fixing element attached to said carrier for fixing substantially the user's heel to said carrier.

13. The medical apparatus of claim 8, wherein said medical apparatus further comprises a supporting element for supporting the user's heel.

14. The medical apparatus of claim 9 wherein said at least one inflatable chamber is inflated and deflated according to a predetermined frequency.

15. The medical apparatus of claim 9 wherein said at least one inflatable chamber features a specific height in its inflated form.

16. The medical apparatus of claim 9 wherein said at least one inflatable chamber is inflated according to a predetermined rate of inflation.

17. The medical apparatus of claim 8, wherein said carrier includes a first elevating element for engaging substantially the front portion of a right foot and a second elevating element for engaging substantially the front portion of a left foot.

18. The medical apparatus of claim 17, wherein said first and second elevating elements are raised independently.

19. The medical apparatus of claim 17, wherein said first and second elevating elements are raised simultaneously.

20. A medical apparatus for facilitating blood circulation in a user's lower limb, comprising:
a first carrier for receiving a user's right foot and a second carrier for receiving a user's left foot , said first carrier including at least one first elevating element for engaging substantially the front portion of the user's right foot relative to the user's right heel and said second carrier including at least one second elevating element for engaging substantially the front portion of the user's left foot relative to the user's left heel.

21. The medical apparatus of claim 20, wherein said first and second elevating elements are raised independently.

22. The medical apparatus of claim 20, wherein said first and second elevating elements are raised simultaneously.

23. A medical apparatus for facilitating blood circulation in a user's lower limb, comprising a sandal element, including:
a sole element having at least one inflatable chamber, the at least one inflatable chamber being adapted to engage substantially the front portion of the user's foot for elevating said front portion of the user's foot relative to the user's heel so as to activate the calf muscles of the user, thereby forcing venous blood upstream towards the user's heart.

24. The medical apparatus of claim 23, wherein said front portion of the user's foot includes the user's toes.

25. The medical apparatus of claim 23, wherein said front portion of the user's foot includes the user's metatarsus.
